(19) United States
(12) Patent Application Publication
(10) Pub. No.: US 2015/0200903 A1
(43) Pub. Date: Jul. 16, 2015

(54) AUTOMATIC EMAIL ADDRESS INPUT PROCESS

(71) Applicant: INTERNATIONAL BUSINESS MACHINES CORPORATION, ARMONK, NY (US)

(72) Inventors: Masaya Fujita, Tokyo (JP); Gautam Majumdar, Wappingers Falls, NY (US); James Moffitt, Milburn, NJ (US); Michael Wang, Irving, TX (US); Fumiyoshi Yamada, Tokyo (JP)

(73) Assignee: INTERNATIONAL BUSINESS MACHINES CORPORATION, ARMONK, NY (US)

(21) Appl. No.: 14/152,274

(22) Filed: Jan. 10, 2014

(51) Int. Cl. H04L 12/58; H04L 29/08

(52) U.S. Cl. CPC H04L 51/32; H04L 67/22

(57) ABSTRACT

A method and system for inputting an email address is provided. The method includes generating an email and receiving a command for entering a character into a recipient field of the email. An address book of a user is queried and in response, a list of candidate recipients is generated. The list is transmitted to a social network adapter communicatively connected to social networks of the user. In response, social networking data of the user is retrieved and the list is sorted with respect to the user and the social network data. The sorted list is presented to the user.

### FIELD

The present invention relates generally to a method for entering an email address and in particular to a method and associated system for automatically presenting a most likely email address candidate based on analyzed social network data.

### BACKGROUND

Determining recipient addresses typically includes an inaccurate process with little flexibility. Inputting recipient addresses may include a complicated process that may be time consuming and require a large amount of resources. Accordingly, there exists a need in the art to overcome at least some of the deficiencies and limitations described herein above.

### SUMMARY

A first aspect of the invention provides a method comprising: generating, by a computer processor of a computing system in response to a user command, an email; receiving, by the computer processor from the user, a command for entering a first character into a recipient field of the email; automatically querying, by the computer processor in response to the command, an address book of the user, wherein the address book comprises email addresses of recipients associated with the user; receiving, by the computer processor in response to the automatically querying and the receiving the first character, a list of candidate recipients of the recipients; transmitting, by the computer processor, the list of candidate recipients to a social network adapter of the user, wherein the social network adapter of the user is communicatively connected to social networks of the user; receiving, by the computer processor from the social network adapter of the user, social networking data of the user; sorting, by the computer processor based on the social networking data, the list of candidate recipients with respect to the user; generating, by the computer processor based on the sorting, a first sorted list of candidate recipients with respect to the user; and presenting, by the computer processor, the first sorted list of candidate recipients for selection by the user.

A second aspect of the invention provides a computing system comprising a computer processor coupled to a computer-readable memory unit, the memory unit comprising instructions that when executed by the computer processor implements a method comprising: generating, by the computer processor in response to a user command, an email; receiving, by the computer processor from the user, a command for entering a first character into a recipient field of the email; automatically querying, by the computer processor in response to the command, an address book of the user, wherein the address book comprises email addresses of recipients associated with the user; receiving, by the computer processor in response to the automatically querying and the receiving the first character, a list of candidate recipients of the recipients; transmitting, by the computer processor, the list of candidate recipients to a social network adapter of the user, wherein the social network adapter of the user is communicatively connected to social networks of the user; receiving, by the computer processor from the social network adapter of the user, social networking data of the user; sorting, by the computer processor based on the social networking data, the list of candidate recipients with respect to the user; generating, by the computer processor based on the sorting, a first sorted list of candidate recipients with respect to the user; and presenting, by the computer processor, the first sorted list of candidate recipients for selection by the user.

A third aspect of the invention provides a computer program product, comprising a computer readable hardware storage device storing a computer readable program code, the computer readable program code comprising an algorithm that when executed by a computer processor of a computer system implements a method, the method comprising: generating, by the computer processor in response to a user command, an email; receiving, by the computer processor from the user, a command for entering a first character into a recipient field of the email; automatically querying, by the computer processor in response to the command, an address book of the user, wherein the address book comprises email addresses of recipients associated with the user; receiving, by the computer processor in response to the automatically querying and the receiving the first character, a list of candidate recipients of the recipients; transmitting, by the computer processor, the list of candidate recipients to a social network adapter of the user, wherein the social network adapter of the user is communicatively connected to social networks of the user; receiving, by the computer processor from the social network adapter of the user, social networking data of the user; sorting, by the computer processor based on the social networking data, the list of candidate recipients with respect to the user; generating, by the computer processor based on the sorting, a first sorted list of candidate recipients with respect to the user; and presenting, by the computer processor, the first sorted list of candidate recipients for selection by the user.

The present invention advantageously provides a simple method and associated system capable of determining recipient addresses.

### BRIEF DESCRIPTION OF THE DRAWINGS

FIG. 1 illustrates a system for automatically presenting a most likely email address candidate based on analyzed social network data, in accordance with embodiments of the present invention.

FIG. 2 illustrates a system flow enabled by the system of FIG. 1, in accordance with embodiments of the present invention.

FIG. 3 illustrates a graphical user interface (GUI) enabled by the system of FIG. 1, in accordance with embodiments of the present invention.

FIG. 4 illustrates an additional GUI enabled by the system of FIG. 1, in accordance with embodiments of the present invention.

FIG. 5 illustrates an algorithm detailing a process flow enabled by the system of FIG. 1 for automatically presenting a most likely email address candidate based on analyzed social network data, in accordance with embodiments of the present invention.

FIG. 6 illustrates an algorithm detailing a sorting step of the algorithm of FIG. 5, in accordance with embodiments of the present invention.

FIG. 7 illustrates a computer apparatus used by the system of FIG. 1 for automatically presenting a most likely email address candidate based on analyzed social network data, in accordance with embodiments of the present invention.

### DETAILED DESCRIPTION

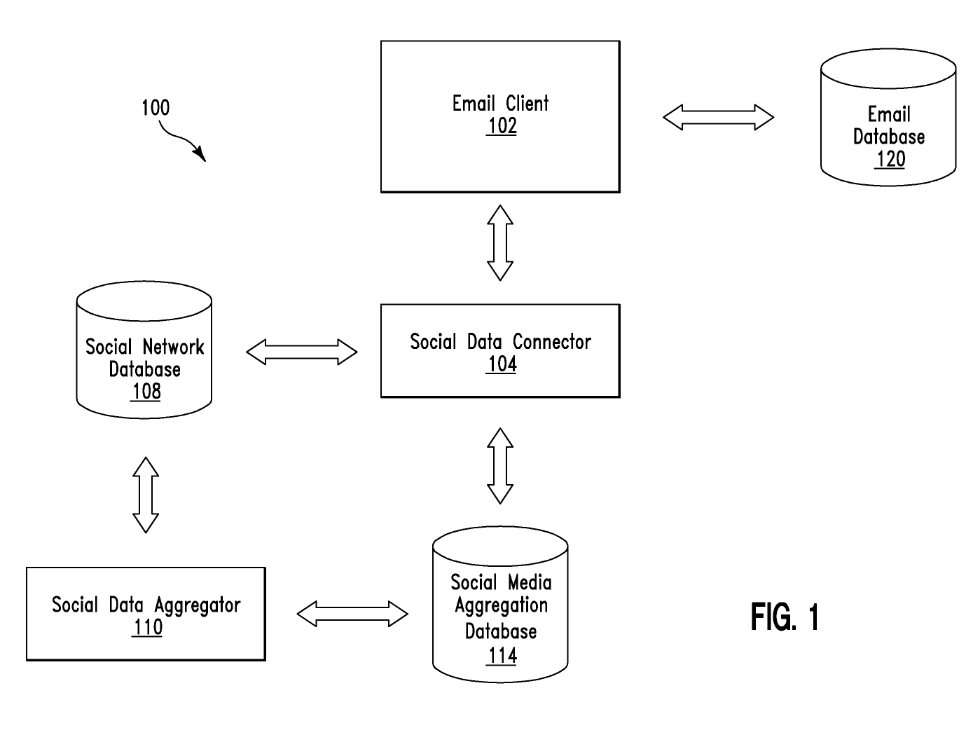

FIG. 1 illustrates a system 100 for automatically presenting a most likely email address candidate based on analyzed social network data, in accordance with embodiments of the present invention. System 100 enables a process for generating a social networking score(s) and dynamically sorting an e-mail address list based on the social networking score(s). In response, a user is presented with e-mail address suggestions for selection for entry into an entry point of an e-mail application. System 100 comprises an email client 102, a social network database 108, and a social media aggregation database 114 connected by a social network connector 104. Additionally, system 100 comprises a social data aggregator 110 (connected to social network database 108, and social media aggregation database 114) and an email database 120 connected to email client 102. Social network connector 104 enables a process for initiating communications between email client 102 and social networking services (e.g., social network database 108, and social media aggregation database 114). System 100 may comprise direct connections to social networks individually. Alternatively, system 100 may comprise connections via social data aggregator 110 to consolidate data from multiple sources before transmitting to email client 102. Additionally, system 100 may comprise direct connections to social networks individually and connections via social data aggregator 110 (i.e., as illustrated in FIG. 1).

System 100 enables the following process with respect to a generated email:

1. Email client 102 monitors a user entering alpha/numeric characters (for an email address) in a recipient field of the generated email.
2. Email client 102 queries an (email) address book of the user.
3. In response to the query, an email server a list of candidates. The list of candidates is generated based on the entered alpha/numeric characters (i.e., in the recipient field of the generated email).
4. Email client 102 passes the user and the list of candidates to social data connector 104 for social network data retrieval.
5. Social data connector 104 returns social network data (of the user) from social network database 108 and/or social media aggregation database 114 to email client 102.
6. Email client 102 sorts the list of candidates based on a social networking data score calculated with respect to the social network data as described, infra.
7. The sorted list of candidates is presented to the user and the user selects an associated email address for entry into the recipient field of the generated email.

Email client 102 sorts the list of candidates based on a sorting algorithm described as follows:

1. Social networks (of the social network database 108 and/or social media aggregation database 114) are prioritized with a focus on business emails. For example, company internal social networks and/or professional social networks may comprise a higher precedence than personal social networks.
2. Social network activity dates are analyzed. For example, if a first social network is accessed with respect to a more current data than a second social network, the first social network may comprise a higher precedence.
3. Social posts of users (of the list of candidates) are analyzed to determine if any of the posts exceed a specified threshold. Users with a number of posts exceeding the specified threshold comprise a lower precedence.
4. Precedence ratings are generated (e.g., ranked with scores of 1 to 5) and precedence scores from multiple social networks are aggregated to a final score. Additionally, the precedence ratings are generated based on the fact that not all users are on all social networks.
5. The list of candidates is passed into social data connector 104 during social network search in order to reduce overall search requirements and traffic as only users on the list are searched.

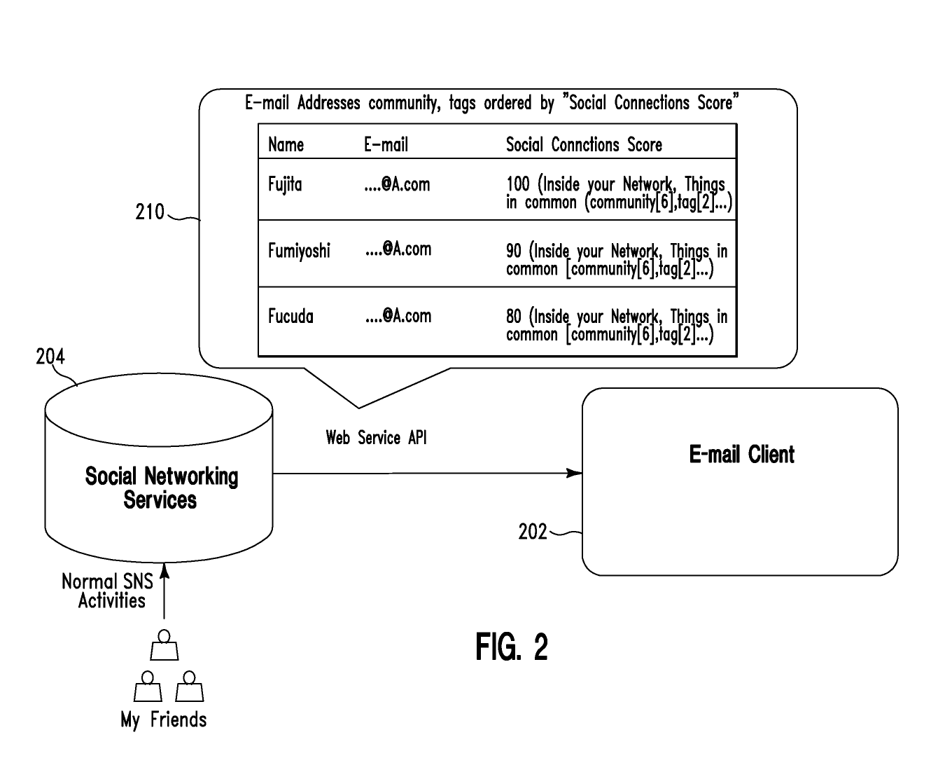

FIG. 2 illustrates a system flow 200 enabled by system 100 of FIG. 1, in accordance with embodiments of the present invention. System flow 200 illustrates e-mail client 202 interacting with externals social networking services 204 for candidate e-mail address retrieval based on a social connections score. The interaction is triggered by a user e-mail address input action or an enabled address book application on e-mail client 202. Email client 202 may use an e-mail, a community name, and/or tags ordered by a social connections score in an e-mail address input or address book. System flow 200 retrieve e-mail addresses, community names and an associated member list or tags and a tagged member list for matching with a user input. The member list is ordered by a social connections score.

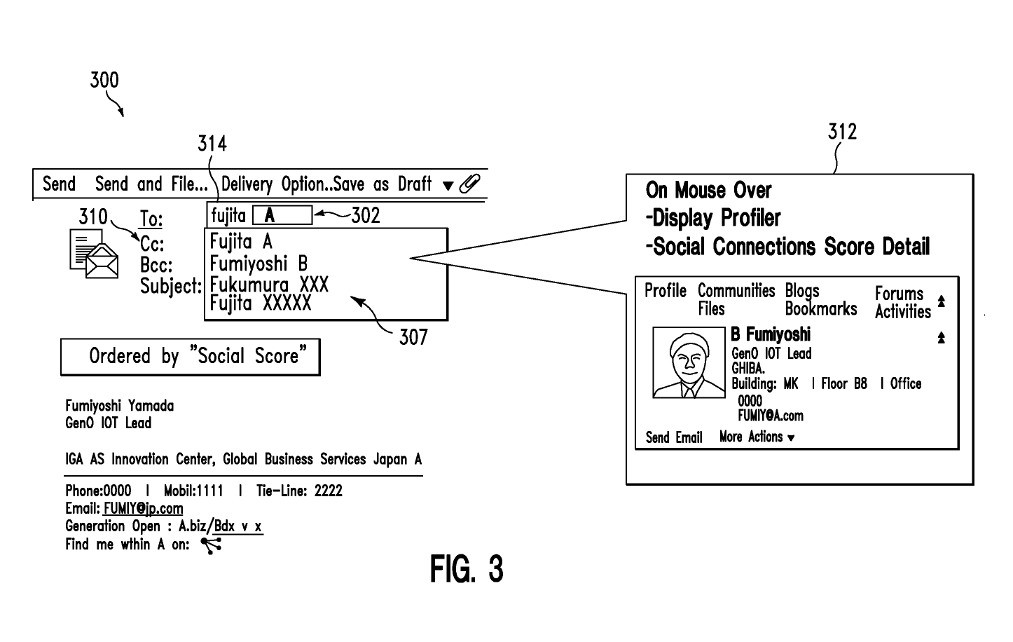

FIG. 3 illustrates a graphical user interface (GUI) 300 enabled by system 100 of FIG. 1, in accordance with embodiments of the present invention. GUI 300 illustrates a dynamic email address suggestion process associated with a social connection score. GUI 300 allows a user to enter character(s) 302 into an address bar 314. In response, candidate e-mail addresses 307 are computed and displayed for the user to set destination field(s) 310. During a mouse-over (or single tap/click of a mouse), a detailed profile information box 312 (e.g., comprising a photo, address, profession, etc.) is displayed. E-mail address suggestions or community tag suggestions are ordered by social connections scores presented to the user after the user inputs characters into address bar 314. When a user selects community or tags, included candidate e-mail addresses 307 are listed for user selection. Social connection scores may be calculated based on common communities, common tags, common forums, common blogs, etc.

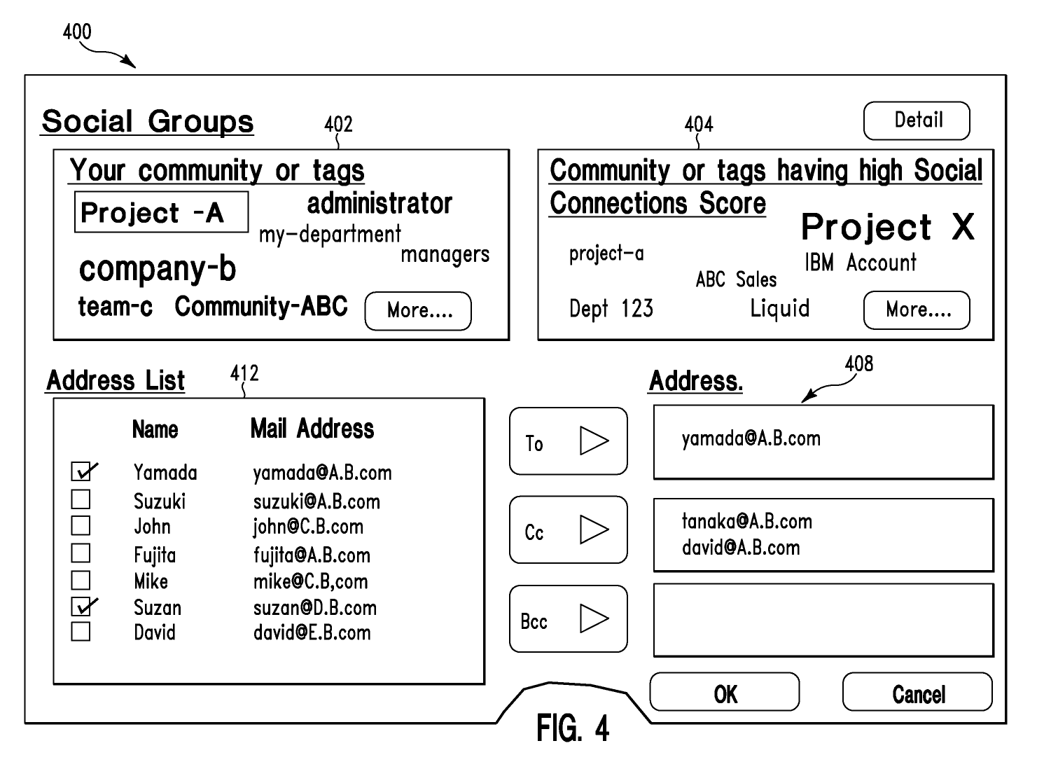

FIG. 4 illustrates a graphical user interface (GUI) 400 enabled by system 100 of FIG. 1, in accordance with embodiments of the present invention. GUI 300 illustrates a social connections score enabled address book application on an e-mail client. Block 402 (your community or tag block) illustrates a community (i.e., a group of people comprising same interests on a social network), name(s), or TAG(s) of an e-mail client (optionally in “tag cloud” format based on a member count). Block 404 (i.e., communities or tags comprising high social connections scores) illustrates computed community name(s) or TAG(s). The computed community name(s) or TAG(s) are displayed based on social connections scores among entered destination field contacts 408. When a user select a group, individual members of the group are listed in address list box 412 to enable the user to set destination fields.

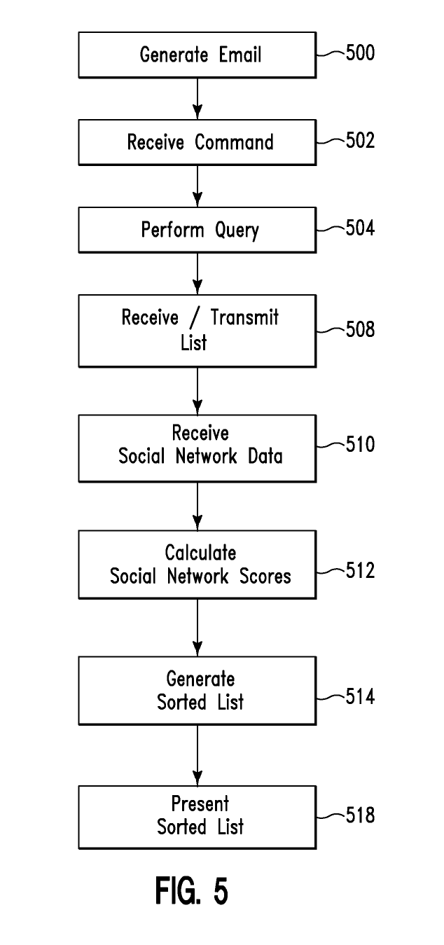

FIG. 5 illustrates an algorithm detailing a process flow enabled by system 100 of FIG. 1 for automatically presenting a most likely email address candidate based on analyzed social network data, in accordance with embodiments of the present invention. Each of the steps in the algorithm of FIG. 5 may be enabled and executed in any order by a computer processor executing computer code. In step 500, an email is generated in response to a user command. In step 502, a command for entering at least one character into a recipient field of the email is received from a user. In step 504 (in response to the command for entering the at least one character), an address book of the user is automatically queried. The address book comprises email addresses of recipients associated with the user. In step 508 (in response to the query process of step 504 and the command of step 502), a list of candidate recipients is received and transmitted to a social network adapter of the user. The social network adapter is communicatively connected to social networks of the user. In step 510, social networking data of the user is received from the social network adapter. In step 512, social connection scores for each candidate recipient of the list of candidate recipients are calculated. In step 514, the list of candidate recipients is sorted (based on the social networking data and the social connection scores) with respect to the user and a sorted list of candidate recipients with respect to the user is generated. In step 518, the sorted list of candidate recipients is presented for selection by the user.

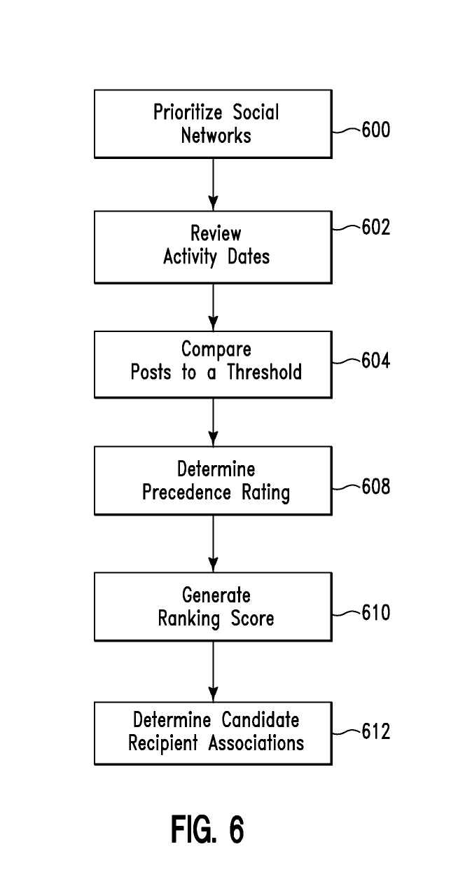

FIG. 6 illustrates an algorithm detailing step 514 of the algorithm of FIG. 5, in accordance with embodiments of the present invention. Each of the steps in the algorithm of FIG. 5 may be enabled and executed in any order by a computer processor executing computer code. In step 600, social networks of the user are prioritized. The social networks may be prioritized based on:

1. A company social network of the user taking higher precedence than all other social networks of the user.
2. A professional social network of the user taking higher precedence than all other social networks of the user.

In step 602, network activity dates associated with user activity with respect to the social networks of the user are reviewed. The reviewing process may include prioritizing candidates of the list of candidate recipients based on recent social network activity. In step 604, social network posts of each candidate recipient are compared to a specified threshold. In step 608 a precedence rating for each candidate recipient is determined based on results of the comparison of step 604. In step 610, a ranking score for each candidate recipient is generated based on each precedence rating. In step 612, a group of candidate recipients is determined to not be associated with all social networks of the user.

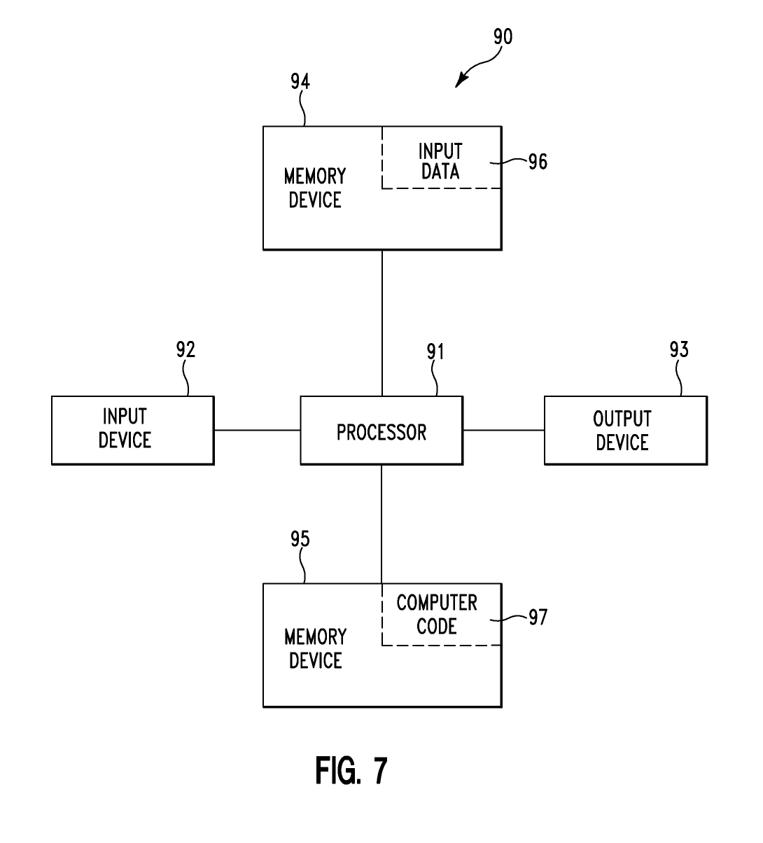

FIG. 7 illustrates a computer apparatus 90 used by system 100 of FIG. 1 for automatically presenting a most likely email address candidate based on analyzed social network data, in accordance with embodiments of the present invention. The computer system 90 includes a processor 91, an input device 92 coupled to the processor 91, an output device 93 coupled to the processor 91, and memory devices 94 and 95 each coupled to the processor 91. The input device 92 may be, inter alia, a keyboard, a mouse, a camera, a touchscreen, etc. The output device 93 may be, inter alia, a printer, a plotter, a computer screen, a magnetic tape, a removable hard disk, a floppy disk, etc. The memory devices 94 and 95 may be, inter alia, a hard disk, a floppy disk, a magnetic tape, an optical storage such as a compact disc (CD) or a digital video disc (DVD), a dynamic random access memory (DRAM), a read-only memory (ROM), etc. The memory device 95 includes a computer code 97. The computer code 97 includes algorithms (e.g., the algorithms of FIGS. 5 and 6) for automatically presenting a most likely email address candidate based on analyzed social network data. The processor 91 executes the computer code 97. The memory device 94 includes input data 96. The input data 96 includes input required by the computer code 97. The output device 93 displays output from the computer code 97. Either or both memory devices 94 and 95 (or one or more additional memory devices not shown in FIG. 7) may include the algorithms of FIGS. 5 and 6 and may be used as a computer usable medium (or a computer readable medium or a program storage device) having a computer readable program code embodied therein and/or having other data stored therein, wherein the computer readable program code includes the computer code 97. Generally, a computer program product (or, alternatively, an article of manufacture) of the computer system 90 may include the computer usable medium (or the program storage device).

Still yet, any of the components of the present invention could be created, integrated, hosted, maintained, deployed, managed, serviced, etc. by a service supplier who offers to automatically present a most likely email address candidate based on analyzed social network data. Thus the present invention discloses a process for deploying, creating, integrating, hosting, maintaining, and/or integrating computing infrastructure, including integrating computer-readable code into the computer system 90, wherein the code in combination with the computer system 90 is capable of performing a method for automatically presenting a most likely email address candidate based on analyzed social network data. In another embodiment, the invention provides a business method that performs the process steps of the invention on a subscription, advertising, and/or fee basis. That is, a service supplier, such as a Solution Integrator, could offer to automatically present a most likely email address candidate based on analyzed social network data. In this case, the service supplier can create, maintain, support, etc. a computer infrastructure that performs the process steps of the invention for one or more customers. In return, the service supplier can receive payment from the customer(s) under a subscription and/or fee agreement and/or the service supplier can receive payment from the sale of advertising content to one or more third parties.

While FIG. 7 shows the computer system 90 as a particular configuration of hardware and software, any configuration of hardware and software, as would be known to a person of ordinary skill in the art, may be utilized for the purposes stated supra in conjunction with the particular computer system 90 of FIG. 7. For example, the memory devices 94 and 95 may be portions of a single memory device rather than separate memory devices.

While embodiments of the present invention have been described herein for purposes of illustration, many modifications and changes will become apparent to those skilled in the art. Accordingly, the appended claims are intended to encompass all such modifications and changes as fall within the true spirit and scope of this invention.

What is claimed is:

1. A method comprising:
generating, by a computer processor of a computing system in response to a user command, an email;
receiving, by said computer processor from said user, a command for entering a first character into a recipient field of said email;
automatically querying, by said computer processor in response to said command, an address book of said user, wherein said address book comprises email addresses of recipients associated with said user;
receiving, by said computer processor in response to said automatically querying and said receiving said first character, a list of candidate recipients of said recipients;
transmitting, by said computer processor, said list of candidate recipients to a social network adapter of said user, wherein said social network adapter of said user is communicatively connected to social networks of said user;
receiving, by said computer processor from said social network adapter of said user, social networking data of said user;
sorting, by said computer processor based on said social networking data, said list of candidate recipients with respect to said user;
generating, by said computer processor based on said sorting, a first sorted list of candidate recipients with respect to said user; and
presenting, by said computer processor, said first sorted list of candidate recipients for selection by said user.

2. The method of claim 1, further comprising:
calculating, by said computer processor, social connection scores for each candidate recipient of said list of candidate recipients, wherein said sorting is further based on said social connection scores.

3. The method of claim 1, wherein said sorting comprises:
prioritizing said social networks of said user;
reviewing social network activity dates associated with user activity with respect to said social networks of said user;
comparing social network posts of each candidate recipient of said list of candidate recipients to a specified threshold;
determining a precedence rating for each said candidate recipient based on results of said comparing;
generating ranking score for each said candidate recipient based on each said precedence rating; and
determining that a group of candidate recipients of said candidate recipients are not associated with all social networks of said social networks of said user.

4. The method of claim 3, wherein said prioritizing is based on a company social network of said social networks of said user taking higher precedence than all other social networks of said social networks of said user.

5. The method of claim 3, wherein said prioritizing is based on a professional social network of said social networks of said user taking higher precedence than all other social networks of said social networks of said user.

6. The method of claim 3, wherein said reviewing said social network activity dates comprises prioritizing candidates of said list of candidate recipients based on recent social network activity.

7. The method of claim 3, further comprising:
aggregating multiple ranking scores for each said candidate recipient based on associations with multiple social networks of said list of social networks.

8. The method of claim 1, wherein said first sorted list of candidate recipients comprises a different order than said list of candidate recipients.

9. The method of claim 1, wherein said first sorted list of candidate recipients comprises a fewer candidates than said list of candidate recipients.

10. The method of claim 1, further comprising:
receiving, by said computer processor from said user, an additional command for entering a second character into said recipient field of said email;
additionally querying, by said computer processor in response to said additional command, said address book of said user
receiving, by said computer processor in response to said additionally querying and said receiving said second character, an alternative list of candidate recipients of said recipients, said alternative list differing from said list;
transmitting, by said computer processor, said alternative list of candidate recipients to said social network adapter of said user;
receiving, by said computer processor from said social network adapter of said user, alternative social networking data of said user;
additionally sorting, by said computer processor based on said alternative social networking data, said alternative list of candidate recipients with respect to said user;
generating, by said computer processor based on said additionally sorting, a second sorted list of candidate recipients with respect to said user, said second sorted list differing from said first sorted list; and
presenting, by said computer processor, said second sorted list of candidate recipients for selection by said user.

11. The method of claim 1, further comprising:
receiving, by said computer processor from said user in response to said presenting, a recipient field selection for a first candidate recipient of said first sorted list of candidate recipients for entering in said recipient field of said email.

12. The method of claim 1, further comprising:
providing at least one support service for at least one of creating, integrating, hosting, maintaining, and deploying computer-readable code in the computing system, said code being executed by the computer processor to implement: said generating said email, said receiving said command, said automatically querying, said receiving said list, said transmitting, said receiving said social networking data, said sorting, said generating said first sorted list, and said presenting.

13. A computing system comprising a computer processor coupled to a computer-readable memory unit, said memory unit comprising instructions that when executed by the computer processor implements a method comprising:
generating, by said computer processor in response to a user command, an email;
receiving, by said computer processor from said user, a command for entering a first character into a recipient field of said email;
automatically querying, by said computer processor in response to said command, an address book of said user, wherein said address book comprises email addresses of recipients associated with said user;
receiving, by said computer processor in response to said automatically querying and said receiving said first character, a list of candidate recipients of said recipients;
transmitting, by said computer processor, said list of candidate recipients to a social network adapter of said user, wherein said social network adapter of said user is communicatively connected to social networks of said user;
receiving, by said computer processor from said social network adapter of said user, social networking data of said user;
sorting, by said computer processor based on said social networking data, said list of candidate recipients with respect to said user;
generating, by said computer processor based on said sorting, a first sorted list of candidate recipients with respect to said user; and
presenting, by said computer processor, said first sorted list of candidate recipients for selection by said user.

14. The computing system of claim 13, wherein said method further comprises:
calculating, by said computer processor, social connection scores for each candidate recipient of said list of candidate recipients, wherein said sorting is further based on said social connection scores.

15. The computing system of claim 13, wherein said sorting comprises:
prioritizing said social networks of said user;
reviewing social network activity dates associated with user activity with respect to said social networks of said user;
comparing social network posts of each candidate recipient of said list of candidate recipients to a specified threshold;
determining a precedence rating for each said candidate recipient based on results of said comparing;
generating ranking score for each said candidate recipient based on each said precedence rating; and
determining that a group of candidate recipients of said candidate recipients are not associated with all social networks of said social networks of said user.

16. The computing system of claim 15, wherein said prioritizing is based on a company social network of said social networks of said user taking higher precedence than all other social networks of said social networks of said user.

17. The computing system of claim 15, wherein said prioritizing is based on a professional social network of said social networks of said user taking higher precedence than all other social networks of said social networks of said user.

18. The computing system of claim 15, wherein said reviewing said social network activity dates comprises
prioritizing candidates of said list of candidate recipients based on recent social network activity.

19. The computing system of claim 15, wherein said method further comprises:
aggregating multiple ranking scores for each said candidate recipient based on associations with multiple social networks of said list of social networks.

20. A computer program product, comprising a computer readable hardware storage device storing a computer readable program code, said computer readable program code comprising an algorithm that when executed by a computer processor of a computer system implements a method, said method comprising:
generating, by said computer processor in response to a user command, an email;
receiving, by said computer processor from said user, a command for entering a first character into a recipient field of said email;
automatically querying, by said computer processor in response to said command, an address book of said user, wherein said address book comprises email addresses of recipients associated with said user;
receiving, by said computer processor in response to said automatically querying and said receiving said first character, a list of candidate recipients of said recipients;
transmitting, by said computer processor, said list of candidate recipients to a social network adapter of said user, wherein said social network adapter of said user is communicatively connected to social networks of said user;
receiving, by said computer processor from said social network adapter of said user, social networking data of said user;
sorting, by said computer processor based on said social networking data, said list of candidate recipients with respect to said user;
generating, by said computer processor based on said sorting, a first sorted list of candidate recipients with respect to said user; and
presenting, by said computer processor, said first sorted list of candidate recipients for selection by said user.
